(19) United States
(12) Patent Application Publication
(10) Pub. No.: US 2007/0074214 A1
(43) Pub. Date: Mar. 29, 2007

(54) Event processing method in a computer system

(75) Inventors: Hiroshi Ueno, Tokyo (JP); Satoshi Kamiya, Tokyo (JP); Koichi Sato, Tokyo (JP); Akihiro Motoki, Tokyo (JP); Kiyohisa Ichino, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/519,228

(22) Filed: Sep. 12, 2006

(30) Foreign Application Priority Data
Sep. 13, 2005 (JP) 2005-265312

(51) Int. Cl. G06F 9/46

(52) U.S. Cl. 718/100

(57) ABSTRACT

A computer system includes a central processing unit (CPU), a plurality of dedicated processing units (DPUs) for transferring therebetween event descriptors for allocating CPU processings to the DPUs. The computer system includes a plurality of event controllers each associated a corresponding one of the DPUs or CPU. The event controller receives the event descriptors issued by the DPUs and enters the event descriptors in a representative-vent queue in the order of the priority of the event descriptors.

### BACKGROUND OF THE INVENTION

(a) Field of the Invention

The present invention relates to an event processing method in a computer system and, more particularly, to an event processing method in a computer system including a central processing unit (CPU) and a dedicated processing unit (DPU) cooperating with the CPU.

The present invention also relates to a method for processing an event in such a computer system.

(b) Description of the Related Art

A computer system is known which includes a CPU and a plurality of associated DPUs, to which specific processings are allocated from the CPU for reducing the burden of the CPU. Such a computer system is described in JP-1993-103036A, for example. FIG. 9 shows an example of such a computer system.

The computer system, generally designated by numeral 200, includes a CPU 210, and a plurality of associated DPUs 220, each of which is configured by, for example, a dedicated I/O controller for performing an input/output processing for peripheral circuits or a digital signal processor (DSP) for performing a dedicated digital signal processing. The DPUs 220 are configured by hardware suited for performing a signal processing allocated thereto, and are connected to the CPU 210 via a peripheral-component-interconnect (PCI) bus 260, for example.

The CPU 210 issues commands to the DPUs 220 via the PCI bus 260 for instructing the DPUs 220 to execute the commands. The CPU 210, after issuing a command, reads out data from a status register 221 of the DPUs 220 through the PCI bus 260 to confirm completion of command execution by the DPUs 220. In an alternative, the DPUs 220 may write data via the PCI bus 260 in an event storage area 222, which is provided in a memory 211 of the CPU 210 for each of the DPUs 220, and the CPU 210 confirms the completion of the command execution by reading the data from the event storage area 222.

In the conventional computer system 200 as described above, if the CPU 210 iteratively executes polling of the status register 221 of the DPUs 220 via the PCI bus 260 to confirm the completion of the event execution, a significant portion of the CPU time is consumed by the polling, thereby raising the problem of waste of the CPU time. In a recent computer system, a high-speed serial bus, such as “PCI Express” or “RapidIO” (trade marks), having a data transfer rate as high as 1-Gbps is generally used as the PCI bus 260. Such a high-speed serial bus incurs a large delay in the parallel-serial conversion, and necessitates a data transfer scheme using a fixed-length packet even if a single word is to be transferred. In this case, the polling by the CPU 210 consumes a larger CPU time and degrades the performance of the computer system.

In the alternative case where the CPU 210 refers to the event storage area 222 of the memory 211 of the CPU 210, to which the DPUs 220 write the event status data, the DPUs 220 write the data in the event storage area 222 independently of each other. Thus, the event storage area 222 is provided in the memory 211 of the CPU 210 for each of the DPUs 220, as shown in FIG. 9. In this case, the CPU 210 must refer to the plurality of event storage areas 222 for confirming the completion of command execution by the DPUs 220, to thereby consume a significant portion of the CPU time. In addition, the DPUs 220 respectively write the data in the memory 211, thereby causing the memory 211 to assume a busy state. This may block the other important task from being executed by the CPU 210.

In another alternative, the CPU 210 may use an interruption routine in which the status data of the event is transferred to the CPU 210. However, although the interruption routine provides a high-speed notification to the CPU 210, the context data or working register data of the program running on the computer 210 must be temporarily saved due to processing the interruption routine. Such a saving generally consumes several hundreds of clock cycles, wasting a large CPU time. Thus, if the DPUs 220 are to be used frequently in the computer system, the interruption routine will not be employed due to a higher cost of the CPU time for the interruption routine.

### SUMMARY OF THE INVENTION

In view of the above problems in the conventional technique, it is an object of the present invention to provide a computer system including at least one CPU and at least one DPU cooperating with the CPU, which is capable of reducing the event processing cost of the CPU time and thereby improving the performance of the CPU.

It is another object of the present invention to provide a method for processing an event in the computer system.

The present invention provides, in a first aspect thereof, a computer system including: a central processing unit (CPU); at least one dedicated processing unit (DPU) coupled with the CPU via a network for transferring event descriptors to the CPU; and an event controller including a representative-event queue and coupled with the CPU and DPU via the network, the event controller receiving the event descriptors transferred from the DPU to enter the event descriptors in the representative-event queue while selecting an order of entering the event descriptors, wherein the CPU receives consecutively the event descriptors from the representative-event queue.

The present invention also provides, in a second aspect thereof, a computer system including: a central processing unit (CPU); at least one dedicated processing unit (DPU) coupled with the CPU via a network for transmitting event descriptors to the CPU; and an event controller coupled with the CPU and DPU via the network for receiving the event descriptors transferred from the DPU, to create a new event descriptor based on a plurality of the event descriptors and issue the new event descriptor to the CPU.

The present invention also provides, in a third aspect thereof, a method for receiving event descriptors issued from at least one dedicated processing unit (DPU) by a central processing unit (CPU) in a computer system, the method including the steps of: receiving the event descriptors from the DPU in an event controller to enter the event descriptors in a representative-event queue by selecting an order of the event descriptors; and consecutively receiving the event descriptors by the CPU from the representative-event queue.

The present invention also provides, in a fourth aspect thereof, a method for receiving event descriptors issued from at least one dedicated processing unit (DPU) by a central processing unit (CPU) in a computer system, the method including the steps of: creating a new event descriptor in an event controller based on event descriptors issued from the DPU; and consecutively receiving the event descriptors by the CPU.

The representative-event queue used in the first and third aspect of the present invention allows the CPU to receive the event descriptors only by referring to the single representative-event queue, thereby reducing the CPU time needed to receive the event descriptors.

The creation of a new event descriptor based on a plurality of event descriptors in the second and fourth aspect of the present invention reduces the burden of the CPU by reducing the CPU time consumed for receiving and combining the event descriptors.

The above and other objects, features and advantages of the present invention will be more apparent from the following description, referring to the accompanying drawings.

### BRIEF DESCRIPTION OF THE DRAWINGS

FIG. 1 is a block diagram of a computer system according to a first embodiment of the present invention.

FIG. 2 is a table showing the contents of an event descriptor used in the computer system of FIG. 1.

FIG. 3 is a detailed block diagram of the CPU and event controller shown in FIG. 1.

FIG. 4 is a block diagram of a practical example of the computer system of FIG. 1.

FIGS. 5A and 5B are tables showing the contents of the event descriptor used in the computer system of FIG. 4.

FIG. 6 is a table tabulating the result of the pattern check processing and the next status judged using a judgement logic based on the result.

FIG. 7 is a block diagram of a computer system according to a second embodiment of the present invention.

FIG. 8 is a block diagram of a computer system according to a third embodiment of the present invention.

FIG. 9 is a block diagram of a conventional computer system.

### PREFERRED EMBODIMENT OF THE INVENTION

Now, the present invention is more specifically described with reference to accompanying drawings, wherein similar constituent elements are designated by similar reference numerals.

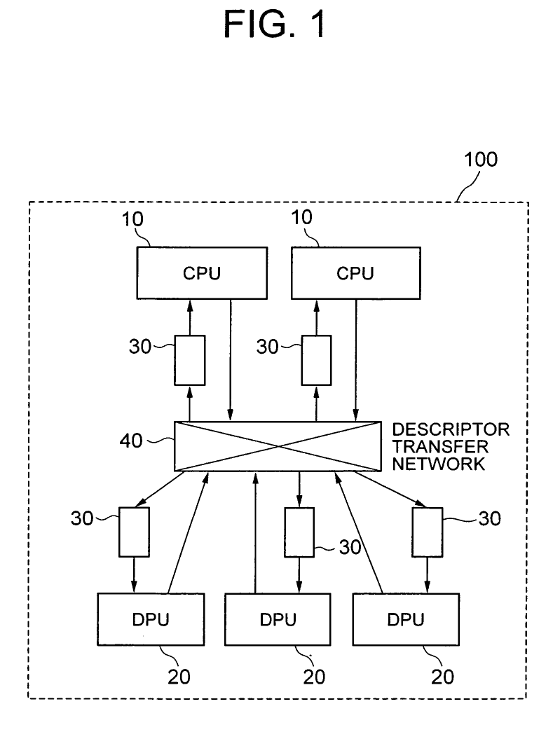

FIG. 1 shows a computer system according to a first embodiment of the present invention. The computer system, generally designated by numeral 100, includes a plurality of (two in this example) CPUs 10 for performing processings based on software, a plurality of associated DPUs 20 cooperating with the CPUs 10, and a plurality of event controllers 30 each provided for a corresponding one of the CPUs 10 and DPUs 20. The DPUs 20 in the present embodiment are configured by dedicated software, DSP, dedicated processor etc. The computer system 100 in the present invention may include at least one CPU 10 and at least one DPU 20.

The CPUs 10 and DPUs 20 each issue an event descriptor upon satisfaction of a specific condition, and transmit the issued event descriptor to a descriptor transfer network 40. The CPUs 10 and DPUs 20 each receive via a corresponding one of the event controllers 30 the event descriptor transferred through the descriptor transfer network 40.

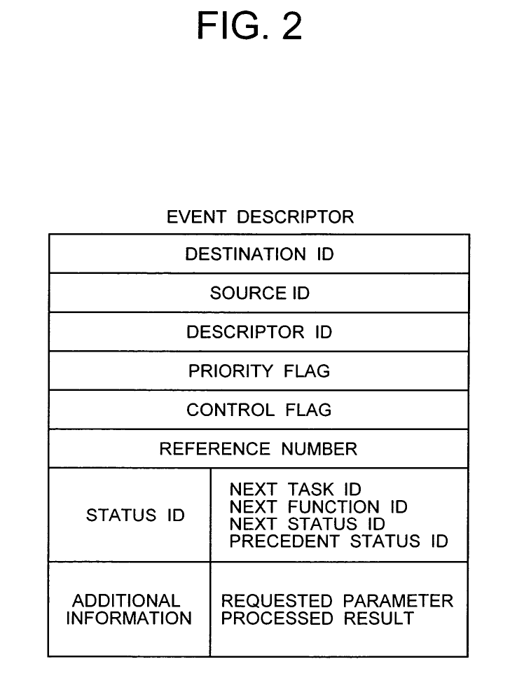

FIG. 2 exemplifies the contents of the event descriptor transferred through the descriptor transfer network 40. The event descriptor includes information of a destination ID, a source ID, a descriptor ID, a priority flag, a control flag, a reference number and status parameters (or status IDs), and additional information. The descriptor ID is used to identify the event descriptor. The destination ID and source ID designate the destination CPU or DPU which is to receive the event descriptor and the source CPU or DPU which issued the event descriptor, respectively. The event transfer network 40 refers to the destination ID and source ID, and transfers the event descriptor to the destination CPU 10 or source DPU 10 specified by the destination ID.

The priority flag designates the degree of priority of the event descriptor in the order of delivery of the event descriptor. The control flag and reference number are referred to by the event controller 30, as will be detailed later. The status IDs, which designate next task ID, next function ID, next status ID and/or precedent status ID, are used by the CPUs 10 to determine the next processing in the CPUs 10. These status IDs or status parameters may be changed by the event controller 30 in an appropriate situation. The additional information includes information of parameters needed by the CPUs 10 and DPUs 20 for executing the event specified by the event descriptor, or the contents of a processed result obtained by executing the event notified by the event descriptor.

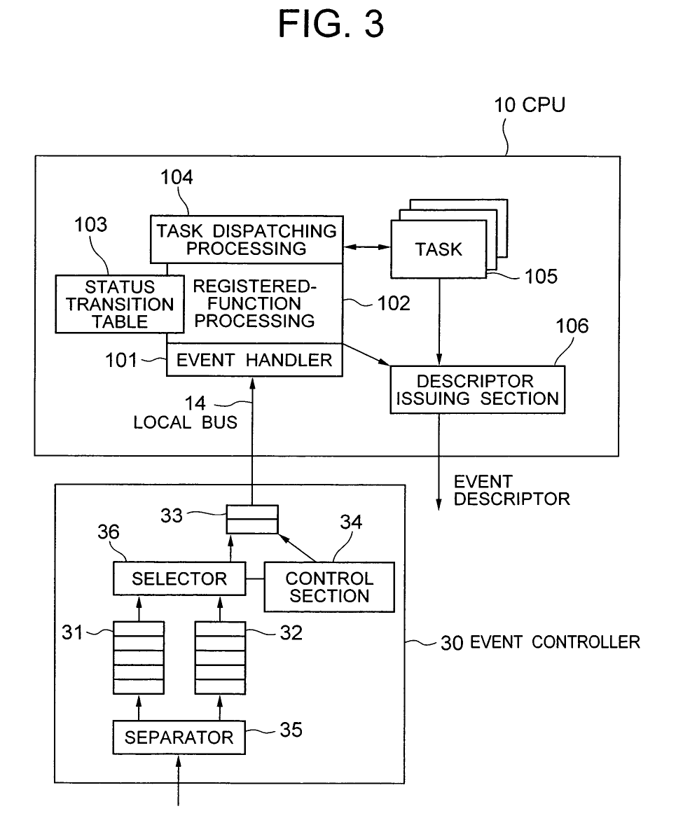

FIG. 3 shows a detailed configuration of one of the CPUs 10 and the associated event controller 30. The programs running on the CPU 10 configure an event handler 101, a registered-function processing section 102, a task dispatching section 104, and a descriptor issuing section 106. The event handler 101 refers to the event descriptor received in the CPU 10 to determine the next processing to be performed in the CPU 10. The registered-function processing section 102 executes a sequence of processings specified thereto beforehand. The task dispatching section 104 determines a task to be started among a plurality of tasks 105. The descriptor issuing section 106 issues an event descriptor.

The CPU 10 uses the registered function processing section 102 or a task 105 during a normal application processing of the CPU 10. In such a normal processing, if the CPU 10 requests a processing by the DPUs 20, the descriptor issuing section 106 of the CPU 10 issues an event descriptor specifying the contents of the processing requested. The DPUs 20, if receive the event descriptor through the associated event controller 30, execute the processing specified by the event descriptor. If transfer of the data stored in the main memory of the CPU 10 is needed for processing by the DPUs 20, the DPUs 20 receive the needed data from the CPU 10 through another data transfer bus such as a PCI bus not shown in the figure.

The DPUs 20, after completion of the processing allocated thereto, issue an event descriptor including a next status ID to the CPU 10. The event handler 101 running on the CPU 10 reads out the event descriptor from the event controller 30 via a local bus 14, and determines the next processing based on the status IDs and processed result in the received event descriptor and a status transition table 103.

If the status IDs specify an event handler task as the next task ID, the event handler 101 starts the registered-function processing section 102 to execute processing of a registered function corresponding to the precedent status ID and the next status ID determined by the processed result. After a sequence of processings is finished by the registered-function processing section 102, the control of CPU 10 is returned to the event handler 101, which receives another event descriptor from the associated event controller 30 and executes a next processing. If the registered-function processing section 102 requests a processing by the DPU 20 to receive therefrom a processed result, processing by the registered-function processing section 102 is stopped and the control of CPU 10 is returned to the event handler 101, which receives the processed result from the DPU 20.

If the next task ID specifies a task other than the event handler task, the event handler 101 allows the task dispatching section 104 to select and call the specified task from among the tasks 105 for execution thereof. Upon calling the task, the context information such as program counter, stack pointer and register information which are stored in the task control block is used for changeover of the tasks. The specified task executes a sequence of processings, then requests a processing by the DPU 20, and returns the control of CPU 10 to the event handler 101. If the specified task awaits a next event such as input/output processing or a timer event, i.e., other than the processing requested to the DPU 20, the control of CPU 10 is also switched to the event handler 101.

The event controller 30 includes a plurality of received-event queues 31, 32, a single representative-event queue 33, a control section 34, a separator 35, and a selector 36. Received-event queue 31 is used to accommodate event descriptors having a higher priority, whereas received-event queue 32 is used to accommodate event descriptors having a lower priority. The separator 35 separates event descriptors received through the descriptor transfer network 40, and enters the separated event descriptors into the received-event queue 31 or 32 based on the priority flag, i.e., depending on the priority of the event descriptors.

The selector 36 fetches an event descriptor from the received-event queue 31 or 32 at a specified timing. The selector 36 affords a priority to the received-event queue 31, and first fetches the event descriptor from received-event descriptor 31 if both the received-event queues 31, 32 accommodate the event descriptor or descriptors. The selector 36 refers to the control flag of the fetched event descriptor, delivers the fetched event descriptor to the control section 34 if the control flag is “1”, and registers the fetched event descriptor in the representative-event queue 33 if the control flag is other than “1”. The representative-event queue 33 includes one or more of storage area for the event descriptor.

The control section 34 is configured by a control processor or hardware. The control section 34, if receives an event descriptor having a control flag set at “1”, executes a processing such as a wait time processing or a judgement processing for status transition based on a judgement logic or program installed therein beforehand, and creates a new event descriptor based on the received event descriptor or descriptors. The control section 34 enters the new event descriptor into the representative-event queue 33. The event descriptor entered into the representative-event queue 33 by the control section 34 or selector 36 is read out by the CPU 10 through the local bus 14.

Operations of the control section 34 will be detailed hereinafter. It is assumed here that the CPU 10 off-loads a CPU processing to three DPUs 20. The CPU 10 issues an event descriptor having a control flag set at “1” and a reference number set at “3” to the three DPUs 20. The DPUs 20 each execute the own processing independently of one other, and issue an event descriptor including the processed result toward the CPU 10. The event descriptors thus issued are received by the event controller 30.

In the event controller 30 disposed for the CPU 10, since the control flag is set at “1”, the selector 36 transfers the received event descriptor to the control section 34. The control section 34 stores information as to which processing is to be executed based on the combination of the precedent processing and the source ID. The control section 34 selects a wait time processing based on the information. In this example, since the reference number is set at “3”, the control section 34 understands waiting of event descriptors from the three DPUs 20.

The control section 34 waits until all the event descriptors from the three DPUs 20 are received, and refers to the processed results of the event descriptors from the three DPUs 20 upon receipt of all the event descriptors. The control section 34 determines the next status ID according to the judgement logic installed therein and based on the combination of the processed results of the event descriptors. Thereafter, the control section 34 creates an event descriptor including the next status ID, and enters the created event descriptor into the representative-event queue 33.

The timing at which the selector 36 fetches the event descriptor from the event queue 31 or 32 is preferably just prior to the timing at which the CPU 10 fetches the event descriptor from the representative-event queue 33. The reason is as follows. The fetching period at which the selector 36 fetches the event descriptor to enter the same into the representative-event queue 33 may be longer than the reference period at which the CPU 10 refers to the representative-event queue 33. In such a case, the CPU 10 may not fetch the event descriptor from the representative-event queue 33 due to the empty thereof, although there is a event descriptor or event descriptors registered in the event queue 31 or 32. If the fetching period at which the selector 36 fetches the event descriptor is set excessively shorter, an event descriptor having a lower priority may be entered into the representative-event queue 33 before another event descriptor having a higher priority, if the latter is received only slightly later than the former.

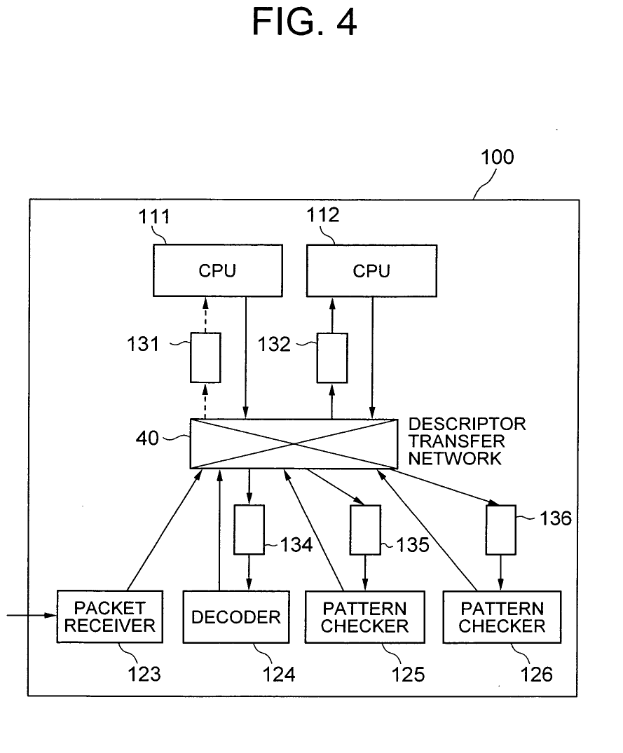

With reference to FIG. 4, the processings of the computer system according to the present embodiment will be described hereinafter while exemplifying a computer system or network processing system including two CPUs 111, 112 and three DPUs including a decoder 124 and two pattern checkers 125, 126. When a packet receiver 123 receives a packet from the external network system, the packet receiver 123 executes a parity check thereof, copies the packet data and stores the copied packet data in the memory of CPU 111 by using a data transfer scheme that is specified beforehand. The packet receiver 123, upon completion of the data transfer, issues to the event controller 131 of CPU 111 a receipt event descriptor including a function ID based on which CPU 111 executes a receiving processing. The function ID is registered beforehand in the packet receiver 123.

CPU 111 fetches the receipt event descriptor from the representative-event queue 33, calls the receipt function based on the next function ID of the receipt event descriptor, and executes processing of packet receipt by using the receipt function. The receipt event descriptor issued by the packet receiver 123 and notifying the packet receipt has a priority lower than the priority of the event descriptor issued by the pattern checkers 125, 126 etc. Due to this priority order, processing of the packet receipt can be deferred if CPU 111 is busy, thereby suppressing occurring of an overflow in the computer system. In addition, the system may use a scheme wherein the events issued by a processing section having a higher frequency of calling the functions have a higher priority, as in the case of a pattern check scheme wherein a single packet data is subjected to a plurality of pattern checks. This prevents accumulation of event descriptors left unattended, to thereby suppress reduction in the processing efficiency.

If CPU 111 needs a decoding processing in a sequence of processings, CPU 111 issues a decoding event requesting the decoding processing to the decoder 124. The decoder 124 receives the event descriptor issued by CPU 111 through the own event controller 134, to start the decoding processing. The decoder 124 receives necessary data from the memory of CPU 111 through a data transfer network not shown, and executes decoding of the data. The decoding processing by the decoder 124 may include decoding of encoded data, decryption of encrypted data, extension of compressed data etc.

The decoder 124, upon completion of the decoding, stores the decoded data in the memory of CPU 111 through the data transfer network, and transmits an event descriptor informing completion of the decoding to CPU 111. This event descriptor is received by the event controller 131 and entered into the representative-event queue 33. CPU 11 fetches the event descriptor indicating the completion of decoding from the representative-event queue 33, and shifts to a next processing based on the next status ID included in the fetched event descriptor. For example, if the task ID in the status IDs specifies other than the task by the event handler 101, CPU 111 starts the specified task 105 by using the task dispatching section 104. In the processing of the task, CPU 111 issues a pattern check event to pattern checker 125 after a sequence of processings are performed.

Pattern checker 125 reads out the event descriptor from the own controller 135, and performs the pattern check. Pattern checker 125, upon completion of the pattern check, determines the next function ID and next task ID based on the result of checking, and issues an event descriptor including those result and IDs to CPU 111. CPU 111 reads out the event descriptor from the representative-event queue 33 of the own event controller 131, and executes a processing based on the next function ID and next task ID in the status IDs of the readout event descriptor. In the computer system, CPUs 111, 112 and DPUs 123 to 126 cooperate in the manner as described above while performing the sequence of processings.

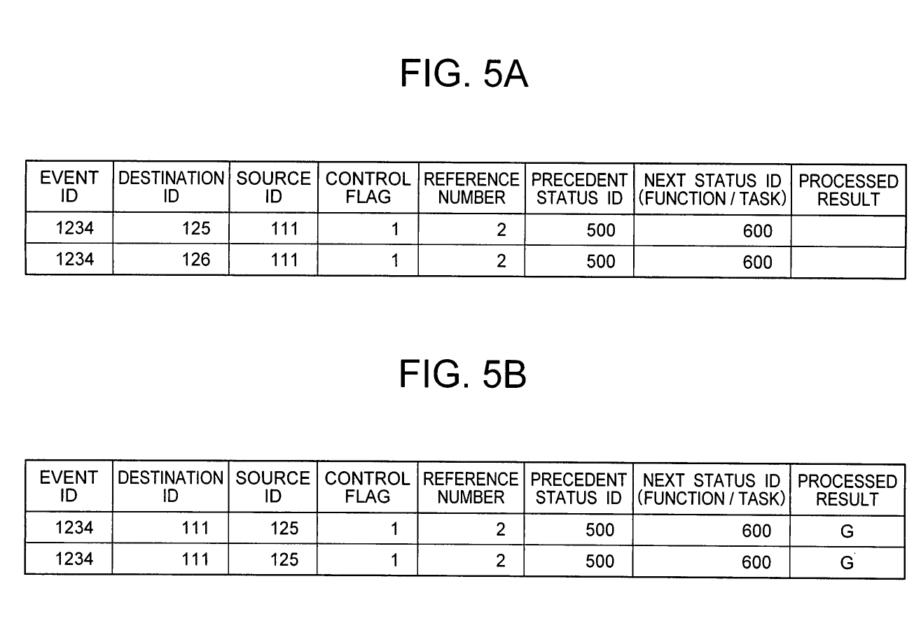

Next, the case wherein CPU 111 uses the two pattern checkers 125, 126 will be described. The pattern checkers 125, 126 execute pattern checking for respective patterns to provide different functions to CPU 111. CPU 111 issues an event for requesting a pattern check by the pattern checker 125 or 126 when a pattern check processing is needed. FIG. 5A shows an example of the contents of the event descriptor issued by CPU 111. The event descriptor includes a descriptor ID indicating a sequential number (1234) of the event, a destination ID specifying pattern checkers 125, 126 to execute the processing of the event, a source ID indicating CPU 111 requesting the event, a control flag, a reference number, a precedent status ID, status IDs such as specifying the next function or task, and a column for processed result. In this example, since the event descriptor includes two destination IDs 125 and 126, the reference number is set at “2”, with the control flag being set at “1” for instructing the control section 34 to receive the event descriptor.

The pattern checkers 125, 126 each receive the event descriptor of FIG. 5A issued by CPU 111, and execute processing of pattern check. The pattern checkers 125, 126, upon completion of the own pattern check, issue the response event descriptor by inserting the processed result in the received event descriptor and reversing the destination ID and source ID, as shown in FIG. 5B. The processed result includes coincidence (Good) or discrepancy (No Good) of the data checked.

The event descriptor issued by pattern checker 125 is received by the event controller 131 of CPU 111, and is delivered from the selector 36 to the control section 34 due to the control flag being set at “1”. The control section 34, upon receiving the response event descriptor issued by pattern checker 125, refers to the precedent status ID and thus recognizes that a wait time processing is needed, and waits the event descriptor from pattern checker 126 by identifying pattern checker 126 based on the descriptor ID. 1234. The control section 34 also recognizes that the wait time processing requires waiting of two event descriptors, based on the reference number, “2”.

Pattern checker 126, upon completion of the pattern check, issues a response event descriptor including the processed result, as in the case of pattern checker 125. The event descriptor issued by pattern checker 126 is delivered from the selector 36 to the control section 34 as well. The control section 34 recognizes, based on the reference number and the descriptor ID, the received event descriptor as the last event descriptor waited in the wait time processing, and terminates the wait time processing. The control section 34 then executes a judgement processing based on the judgement logic while using the two event descriptors, and then issues a new event descriptor.

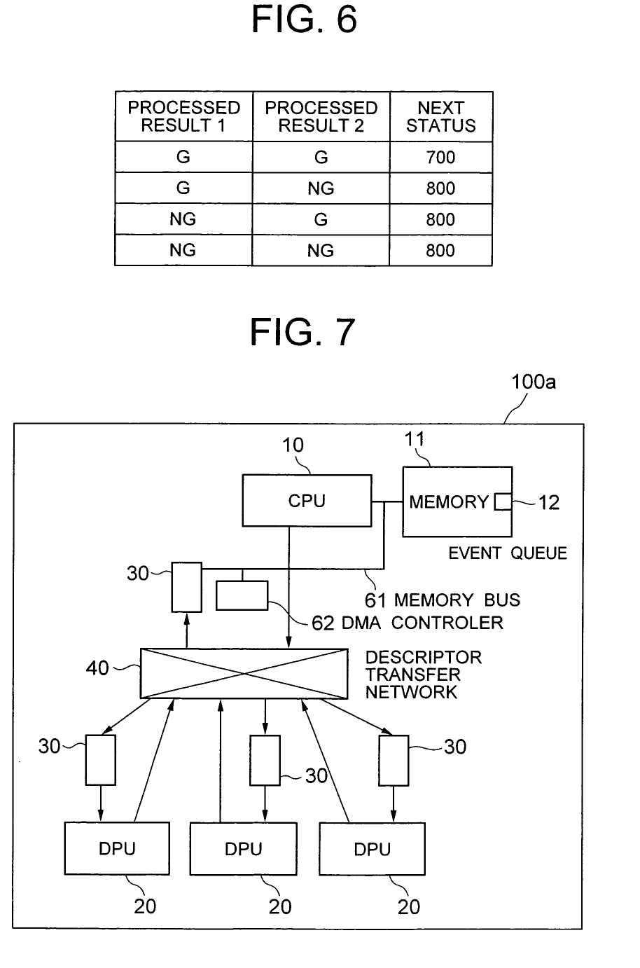

FIG. 6 shows the judgement logic table stored in the control section 34. This judgement logic table is used in the case that the source ID specifies pattern checker 125 or 126, and the precedent status ID is 500. The control section 34 refers to the processed result of the two event descriptors waited in the wait time processing and uses the judgement logic table to determine the next status ID. For example, if the processed result of both the pattern checkers 125, 126 is “Good”, the next status ID is set at “700”, whereas if the processed result of at least one of the pattern checkers 125, 126 is “No Good”, the next status ID is set at “800”.

The control section 34, after determining the next status ID, issues an event descriptor including the thus determined next status ID and including the contents of the event descriptors from the pattern checkers 125, 126, and enters the issued event descriptor into the representative-event descriptor 33. The event descriptor issued by the control section 34 includes additional information indicating the processed result as shown in FIG. 2. CPU 111 receives this event descriptor through the representative-event queue 33, starts a suitable registered function in the registered function processing section 102 or a task 105 based on the processed result of the pattern checkers 125, 126 to continue the processing. Thus, CPU 111 can shift to the next processing status by referring to a single event descriptor issued by the control section 34 and including the processed result of both the pattern checkers 125, 126 executing the processing requested by CPU 111.

As described heretofore, in the computer system of the present embodiment, the event controller 30 enters the event descriptor issued by CPU 10 or DPU 20 into the single representative-event queue 33, and CPU 10 etc. reads out the event descriptor from the representative-event queue through the local bus 14. This allows CPU 10 to receive the event descriptor issued by the DPUs 20 or the other CPU 10 by referring to the single event queue, and thus reduces the cost of CPU time needed for processing the event. Read-out of the vent descriptor via the local bus 14 provides a higher-speed access compared to the conventional case in which the CPU 210 executes polling for the DPUs 220 via the data transfer bus 260, thereby improving the efficiency for operating the CPU 10.

In the above embodiment, the control section 34 of the event controller 30 receives an event descriptor having a control flag set at “1”, and executes a wait time processing or status transition judgement. The wait time processing allows the control section 34 to create a single event descriptor based on a plurality of event descriptors issued by a plurality of DPUs 20. The status transition judgement allows the control section 34 to create an event descriptor including the result thereof. The event descriptor thus created by the event controller 30 reduces the burden of the CPU 10 due to allocation of some of the CPU processings to the event controller 30. This simplifies the application program of the CPU 10 and improves the efficiency for operating the CPU 10.

FIG. 7 shows a computer system according to a second embodiment of the present invention. The computer system, generally designated by numeral 100a, is similar to the computer system 100 of the first embodiment except that the computer system 100a includes a direct-memory-access (DMA) controller 62, and the CPU 10 reads out the event descriptor from a single event queue area 12 of the memory 11 of the CPU 10 in the present embodiment. The memory 11 is coupled to the CPU 10 via a memory bus 61, which may be PCI bus, PCI Express, Rapid I/O bus etc.

The event controller 30 enters an event descriptor in the single representative-event queue 33 (FIG. 3), similarly to the processing in the first embodiment. The DMA controller 62 transfers the event descriptor accommodated in the representative-event queue 33 of the event controller 30 to the event queue area 12 by using the DMA function thereof without an intervention of the CPU 10. The CPU 10 executes polling for the memory 11 and reads out the event descriptor from the event queue area 12 of the memory 11 for processing of the event descriptor.

In the present embodiment, the event descriptor accommodated in the representative-event queue 33 is transferred to the event queue area 12 of the memory 11 of the CPU 11. This also allows the CPU 10 to receive the event descriptor only by referring to the single event queue area 12 of the memory 11. A high-speed access generally used in the memory bus between the CPU 10 and the memory 11 allows the CPU 10 to refer to the event descriptor at a higher speed compared to the case of using the local bus. This is especially effective if the event descriptor has a large data size.

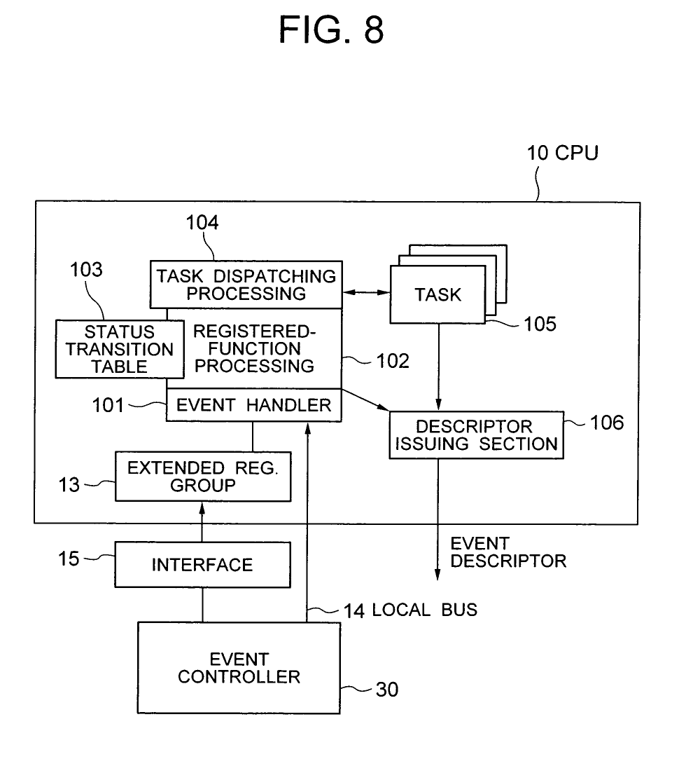

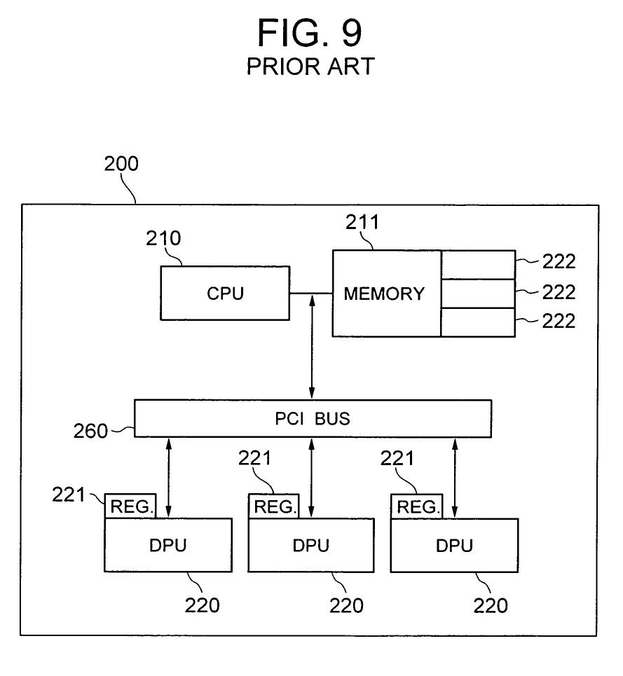

FIG. 8 shows detail of the vicinity of the CPU in a computer system according to a third embodiment of the present invention. The computer system of the present embodiment is similar to the computer system 100 of the first embodiment except that the CPU 10a in the present embodiment additionally includes an extended register group 13. The extended register group 13 stores therein digest information of the representative-event queue 33 (FIG. 3) of the event controller 30. The digest information includes information as to whether or not the representative-event queue stores therein an event descriptor, and a next status ID needed for CPU processing.

The CPU 10a collects the digest information from the event controller 30 through the interface 15, and stores the collected information in the extended register group 13. The CPU 10a acquires information as to presence or absence of an event descriptor in the representative-event queue and the next status ID only by referring to the extended register group. The processing of the register access by the CPU 10a is generally performed at a highest speed among others, whereby the CPU 10a can access the extended register group at a higher speed compared to the case of polling for the event descriptor via the local bus 14. This reduces the access time for accessing the event controller 30 by the CPU 10a, thereby improving the efficiency for operating the CPU 10a.

In the above embodiments, the event descriptor includes a priority order specifying the order of receipt by the CPU. However, the event descriptor does not necessarily include the priority order. In such a case, the event controller 30 enters the event descriptors in the order of receipt by the event controller 30. In addition, the separator 35 may transfer an event descriptor to the control section 34 without an intervention of the event queue 31 or 32 and the selector 36, so long as the control flag of the event descriptor is set at “1”. The event controller 30 of the CPU 10 may have a configuration different from the configuration of the event controller 30 of the DPUs 20. For example, the event controller 30 of the DPUs 20 may consist of the representative-event queue 33.

In the first embodiment, the control section 34 executes a wait time processing for waiting the event descriptors from the pattern checkers 125, 126, determines the next status ID based on the result of the wait time processing, and creates a single event descriptor. However, the control section 34 may execute the wait time processing without the subsequent processings. In such a case, the control section 34 enters the two event descriptors into the representative-event queue 33 at the timing of receipt of the last event descriptor, without executing the status transition judgement. This also allows the CPU 10 to fetch the two event descriptors without executing the wait time processing.

Since the above embodiments are described only for examples, the present invention is not limited to the above embodiments and various modifications or alterations can be easily made therefrom by those skilled in the art without departing from the scope of the present invention.

What is claimed is:

1. A computer system comprising:
a central processing unit (CPU);
at least one dedicated processing unit (DPU) coupled with said CPU via a network for transferring event descriptors to said CPU; and
an event controller including a representative-event queue and coupled with said CPU and DPU via said network, said event controller receiving said event descriptors transferred from said DPU to enter said event descriptors in said representative-event queue while selecting an order of entering said event descriptors,
wherein said CPU receives consecutively said event descriptors from said representative-event queue.

2. The computer system according to claim 1, wherein said event controller includes:
a plurality of received-event queues;
a separator for sorting said event descriptors based on information of said event descriptors to enter said event descriptors into respective said received-event queues based on said sorting; and
a selector for selecting one of said received-event queues to enter at least one of said event descriptors accommodated in said selected one of said received-event queues into said representative-event queue.

3. The computer system according to claim 2, wherein said separator sorts said event descriptors based on a priority order of each of said event descriptors.

4. The computer system according to claim 1, wherein said CPU receives said event descriptors from said representative-event queue via a local bus.

5. The computer system according to claim 1, further comprising a direct-memory-access controller for consecutively storing said event descriptors accommodated in said representative-event queue into a memory of said CPU.

6. The computer system according to claim 1, wherein said event descriptors each include a status parameter for specifying a next processing of said CPU, and said CPU selects one of status transition processing, registered function processing and task dispatching processing based on said status parameter.

7. The computer system according to claim 1, wherein said event controller issues a new event descriptor based on information of a plurality of said event descriptors received from a plurality of said DPU, to enter said new event descriptor into said representative-event queue.

8. The computer system according to claim 7, wherein said event controller starts a wait time processing based on information of one of said event descriptors, and creates said new event descriptor based on said plurality of said event descriptors waited in said wait time processing.

9. The computer system according to claim 1, wherein said CPU includes an extended register for storing therein digest information of said event descriptors.

10. A computer system comprising:
a central processing unit (CPU);
at least one dedicated processing unit (DPU) coupled with said CPU via a network for transmitting event descriptors to said CPU; and
an event controller coupled with said CPU and DPU via said network for receiving said event descriptors transferred from said DPU, to create a new event descriptor based on a plurality of said event descriptor and issue said new event descriptor to said CPU.

11. A method for receiving event descriptors issued from at least one dedicated processing unit (DPU) by a central processing unit (CPU) in a computer system, said method comprising the steps of:
receiving said event descriptors from said DPU in an event controller to enter said event descriptors in a representative-event queue by selecting an order of said event descriptors; and
consecutively receiving said event descriptors by said CPU from said representative-event queue.

12. The method according to claim 11, wherein said receiving step by said event controller includes the steps of:
sorting said event descriptors based on information of said event descriptors to enter said event descriptors into a plurality of received-event queues based on said sorting; and
selecting one of said received-event queues to enter at least one of said event descriptors accommodated in said selected one of said received-event queues into said representative-event queue.

13. The method according to claim 12, wherein said sorting step sorts said event descriptors based on a priority order of each of said event descriptors.

14. The method according to claim 11, wherein said consecutively receiving step by said CPU receives said event descriptors from said representative-event queue via a local bus.

15. The method according to claim 11, said consecutively receiving step by said CPU includes the step of consecutively storing said event descriptors accommodated in said representative-event queue into a memory of said CPU by using a direct-memory-access controller.

16. The method according to claim 11, wherein said event descriptors each include a status parameter for specifying a next processing of said CPU, further comprising the step of selecting one of status transition processing, registered function processing and task dispatching processing based on said status parameter in said CPU.

17. The method according to claim 11, wherein said receiving step by said event controller includes the steps of: issuing a new event descriptor based on information of a plurality of said event descriptors received from a plurality of said DPU, and entering said new event descriptor into said representative-event queue.

18. The method according to claim 17, wherein said new event descriptor issuing step includes the steps of starting a wait time processing based on information of one of said event descriptors, and creating said new event descriptor based on said plurality of said event descriptors waited in said wait time processing step.

19. The method according to claim 11, further comprising the step of storing digest information of said event descriptors in an extended register of said CPU.

20. A method for receiving event descriptors issued from at least one dedicated processing unit (DPU) by a central processing unit (CPU) in a computer system, said method comprising the steps of:
creating a new event descriptor in an event controller based on event descriptors issued from said DPU; and
consecutively receiving said event descriptors by said CPU.
